(19) United States
(12) Patent Application Publication
(10) Pub. No.: US 2020/0013283 A1
(43) Pub. Date: Jan. 9, 2020

(54) ROADSIDE DEVICE, ON-BOARD DEVICE, AND VEHICLE

(71) Applicant: Panasonic Intellectual Property Management Co., Ltd., Osaka (JP)

(72) Inventors: MAKOTO SATO, Kanagawa (JP); FUMIO KOSUGE, Tokyo (JP)

(21) Appl. No.: 16/319,534

(22) PCT Filed: Jul. 6, 2017
(86) PCT No.: PCT/JP2017/024771

§ 371 Date: Jan. 22, 2019

(30) Foreign Application Priority Data
Aug. 3, 2016 (JP) 2016-153247

(51) Int. Cl. G08G 1/0967; G08G 1/16; G08G 1/0969; B60W 30/12; B60W 30/09; G06K 9/00; G05D 1/02; H04L 29/08

(52) U.S. Cl. CPC G08G 1/096783; G08G 1/167; G08G 1/0969; H04L 67/12; B60W 30/09; G06K 9/00825; G05D 1/0274; B60W 30/12

(57) ABSTRACT

A roadside device is configured to adapt to a vehicle road including at least a first lane and a second lane. The roadside device includes an input circuit configured to receive input of traffic light information of a traffic light for the first lane and an output circuit. The output circuit outputs the traffic light information, first road information corresponding to the first lane, second road information at least partially corresponding the second lane, and information that the second road information is substituted for the first road information.

### TECHNICAL FIELD

The present invention relates to a communication technique, and in particular, to a roadside device, an on-board device, and a vehicle that transmit or receive signals containing predetermined information.

### BACKGROUND ART

To prevent drivers from missing road restriction information and to reduce traffic accidents, transmitters are provided in devices such as traffic lights. The transmitter transmits restriction information including road signs, road markings, and traffic lights. Receivers mounted on vehicles receive and processes the restriction information for the purpose of displaying the restriction information on displays (for example, see PTL 1).

### CITATION LIST

### Patent Literature

PTL 1: Unexamined Japanese Patent Publication No. H8-269921

### SUMMARY OF THE INVENTION

The present invention provides a technique of allowing a plurality of vehicles to travel safely during traffic restrictions.

An aspect of the present invention is a roadside device that is configured to adapt to a vehicle road including at least a first lane and a second lane. The roadside device includes an input circuit configured to receive input of state information of a traffic light for the first lane and an output circuit. When the state information of the traffic light input to the input circuit indicates prohibition of traffic, the output circuit outputs first road information corresponding to the first lane, second road information at least partially corresponding the second lane, and information that the second road information is substituted for the first road information.

Another aspect of the present invention is an on-board device that is configured to be mounted on a vehicle that is capable of travelling on a vehicle road including at least a first lane and a second lane. The on-board device includes an input circuit and an output circuit. When the input circuit receives input of first road information corresponding to the first lane, second road information at least partially corresponding the second lane, and information that the second road information is substituted for the first road information before the vehicle travels in the first lane, the output circuit outputs information to the vehicle to cause the vehicle to travel on a second road indicated by the second road information instead of a first road indicated by the first road information.

Yet another aspect of the present invention is a vehicle that is capable of travelling on a vehicle road including at least a first lane and a second lane and of self-driving. The vehicle includes an input circuit. When the input circuit receives input of first road information corresponding to the first lane, second road information at least partially corresponding the second lane, and information that the second road information is substituted for the first road information before the vehicle travels in the first lane during self-driving, the vehicle travels based on the second road information corresponding to the second lane instead of the first road information corresponding to the first lane.

Any combinations of the above-described components and modifications of the features of the present invention in methods, devices, systems, recording media, and computer programs are still effective as other aspects of the present invention.

The present invention allows a plurality of vehicles to travel safely during traffic restrictions.

### BRIEF DESCRIPTION OF DRAWINGS

FIG. 1 is a diagram illustrating a configuration of a communication system according to a first exemplary embodiment of the present invention.

FIG. 2 is a diagram illustrating a configuration of a roadside device illustrated in FIG. 1.

FIG. 3 is a table showing a data structure of traffic light information transmitted from the roadside device illustrated in FIG. 2.

FIG. 4 is a diagram illustrating a configuration of a vehicle illustrated in FIG. 1.

FIG. 5 is a flowchart illustrating a transmission procedure to be performed by the roadside device illustrated in FIG. 2.

FIG. 6 is a flowchart illustrating a reception procedure to be performed by the on-board device in the vehicle illustrated in FIG. 4.

FIG. 7 is a diagram illustrating a configuration of a communication system according to a second exemplary embodiment of the present invention.

FIG. 8 is a table showing a data structure of traffic light information transmitted from a roadside device according to the second exemplary embodiment of the present invention.

FIG. 9 is a flowchart illustrating a transmission procedure to be performed by the roadside device according to the second exemplary embodiment of the present invention.

FIG. 10 is a flowchart illustrating a reception procedure to be performed by an on-board device according to the second exemplary embodiment of the present invention.

### DESCRIPTION OF EMBODIMENTS

Prior to describing exemplary embodiments of the present invention, problems found in a conventional technique will be discussed briefly. A self-driving vehicle includes a sensor. The self-driving vehicle determines a route based on map data stored while reflecting a detection result of the sensor and travels along the determined route. Such a vehicle also uses information received to determine a route. In a case of traffic restrictions due to construction, if a traffic light that indicates whether a vehicle can pass a traffic restriction point is installed at a temporary location that is not included in the map data, the self-driving vehicle may miss the status of the traffic light.

### First Exemplary Embodiment

Prior to specifically describing the exemplary embodiments of the present invention, an outline of the present invention will be described herein. A first exemplary embodiment of the present invention relates to a communication system that performs communication between a roadside device installed on a road and an on-board device mounted on a vehicle. A self-driving vehicle is assumed in the description. Further, assuming that the road on which the vehicle travels is restricted due to road construction or the like and a traffic light is temporarily installed near a construction site for the purpose of guiding the vehicle travelling on the road. A roadside device that is connected to the traffic light is also temporarily installed for the purpose of transmitting information such as the status of the traffic light (hereinafter, “traffic light information”).

The vehicle determines a route based on map data stored and travels along the route. As the on-board device mounted on the vehicle receives traffic light information, the vehicle stops or travels based on the traffic light information. When traffic restrictions are imposed on the road, the vehicle must set a bypass to avoid the construction site. In most cases, however, the traffic light is temporarily installed near the construction site, and thus information about the position of the traffic light and the like is hardly stored in map data held by the self-driving vehicle. Consequently, the self-driving vehicle may miss the status of the traffic light. For this reason, the roadside device transmits a bypass that avoids a traffic regulation point together with information about the position and status of the traffic light. The self-driving vehicle can thus bypass the traffic regulation point reliably. In addition, a plurality of vehicles including an oncoming vehicle passing the traffic regulation point can travel safely.

To handle such a case, the roadside device according to the present exemplary embodiment also transmits information that indicates a bypass (hereinafter, “bypass information”). When receiving bypass information, the on-board device outputs the bypass information to the vehicle. When the bypass information is input to the vehicle, the vehicle changes a route determined based on map data (hereinafter, “self-driving route”) to a bypass indicated by the bypass information and travels along the bypass. After the vehicle travels along the bypass, the on-board device causes the vehicle to travel along the self-driving route again. That is, the on-board device causes the vehicle to return to the self-driving route, which is not the bypass route indicated by the bypass information.

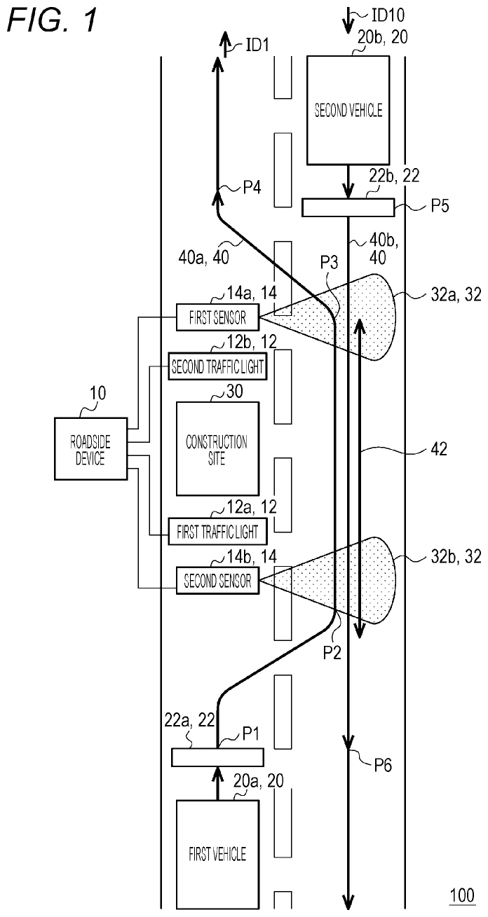

FIG. 1 is a diagram illustrating a configuration of communication system 100 according to the first exemplary embodiment of the present invention. Communication system 100 includes roadside device 10, first traffic light 12a and second traffic light 12b that are collectively referred to as traffic light 12, and first sensor 14a and second sensor 14b that are collectively referred to as sensor 14. First sensor 14a forms first detection range 32a and second sensor 14b forms second detection range 32b. First detection range 32a and second detection range 32b are collectively referred to as detection range 32. There are first vehicle 20a and second vehicle 20b that are collectively referred to as vehicle 20, first stop line 22a and second stop line 22b that are collectively referred to as stop line 22, and construction site 30 on a road. First bypass 40a and second bypass 40b that are collectively referred to as bypass 40 are also set.

On the road illustrated in FIG. 1, a lane on which a vehicle travels from bottom to top of the drawing is adjacent to a lane on which a vehicle travels from top to bottom of the drawing. That is, the road is a two-lane road. It is assumed that identification (ID) “ID1” is given to the former lane and ID “ID10” is given to the latter lane. It is assumed that construction site 30 is on “ID1” lane. The lane that is closed to traffic by construction site 30 or the like is also referred to as “inbound lane” and the lane opposite to the inbound lane is also referred to as “outbound lane”. Consequently, “ID1” lane is “inbound lane” and “ID10” lane is “outbound lane”.

Roadside device 10 is configured to adapt to a vehicle road including at least a first lane and a second lane such as “ID1” lane (first lane) and “ID10” lane (second lane) illustrated in FIG. 1. Roadside device 10 may also be configured to adapt to a vehicle road including at least a first lane and a second lane in its width direction. Moreover, roadside device 10 may be configured to adapt to a vehicle road including, for example, a third lane. In this lane, the first lane and the second lane are connected to the third lane.

It is assumed that vehicle 20 is a vehicle that can travel along the vehicle road including at least the first lane and the second lane and can self-drive.

First traffic light 12a and second traffic light 12b are temporarily placed so as to sandwich construction site 30 on the inbound lane. First traffic light 12a is a traffic light that controls traveling in the inbound lane and second traffic light 12b is a traffic light that controls travelling in the outbound lane. First traffic light 12a and second traffic light 12b are connected to a traffic control center (not shown) and turn green or red based on instructions from the traffic control center. The color of first traffic light 12a is different from that of second traffic light 12b. For example, when first traffic light 12a is red, second traffic light 12b is green. When first traffic light 12a is green, second traffic light 12b is red.

When first traffic light 12a is red, first vehicle 20a travelling in the inbound lane stops at first stop line 22a. When second traffic light 12b is red, second vehicle 20b travelling in the outbound lane stops at second stop line 22b. First sensor 14a is temporarily placed near second traffic light 12b and second sensor 14b is temporarily placed near first traffic light 12a. First sensor 14a forms first detection range 32a and second sensor 14b forms second detection range 32b. Sensor 14 is, for example, a millimeter-wave radar or a stereo camera, and detects vehicle 20 entering detection range 32 as an obstacle.

Roadside device 10 is temporarily placed near construction site 30 and is connected to traffic light 12 and sensor 14. Traffic light information is input from traffic light 12 to roadside device 10. Traffic light information includes a status and a time before status change. The status indicates the color of traffic light 12, for example, “red” or “green. The time before status change indicates a time during which the current color “red” changes to “green” or a time during which the current color “green” changes to “red”. Detection results are also input from sensor 14 to roadside device 10.

Roadside device 10 generates a packet signal based on the traffic light information input and the detection result. Roadside device 10 stores in advance bypass information that indicates bypasses when traffic regulations are imposed on a road and stores the bypass information in the packet signal. For example, a bypass for vehicle 20 travelling in the inbound lane is first bypass 40a. A bypass for vehicle 20 travelling in the outbound lane is second bypass 40b. Roadside device 10 is compatible with intelligent transport system (ITS) in the 700 MHz band, for example, and broadcasts the packet signal.

Vehicle 20 is in a self-driving mode and travels along a self-driving route. When an on-board device (not shown) mounted on vehicle 20 receives a packet signal from roadside device 10, vehicle 20 sets bypass 40 indicated by bypass information included in the packet signal instead of the self-driving route. When vehicle 20 determines that vehicle 20 can travel along bypass 40, based on traffic light information included in the packet signal and the like, vehicle 20 travels along bypass 40. After vehicle 20 travels along bypass 40, vehicle 20 travels along the self-driving route again.

First vehicle 20a travels along the self-driving route until reaching point “P1”. At point “P1”, first vehicle 20a changes the self-driving route to first bypass 40a. First vehicle 20a travels along first bypass 40a through points “P1”, “P2”, “P3”, and “P4”. At point “P4”, first vehicle 20a changes first bypass 40a to the self-driving route and then travels along the self-driving route. Second vehicle 20b travels along the self-driving route until reaching point “P5”. At point “P5”, second vehicle 20b changes the self-driving route to second bypass 40b. Second vehicle 20b travels along second bypass 40b between points “P5” and “P6”. At point “P6”, second vehicle 20b changes second bypass 40b to the self-driving route and then travels along the self-driving route.

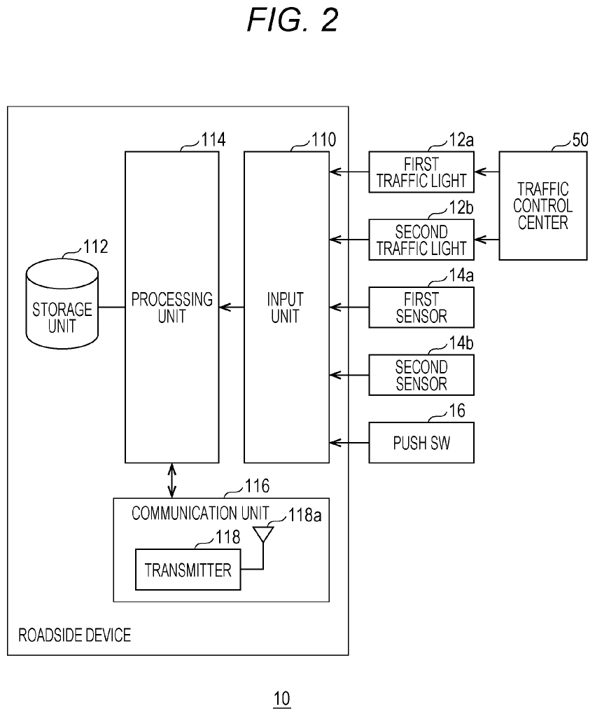

FIG. 2 illustrates a configuration of roadside device 10. Roadside device 10 includes input unit 110, storage unit 112, processing unit 114, and communication unit 116. Communication unit 116 includes transmitter 118. Input unit 110 is connected to first traffic light 12a, second traffic light 12b, first sensor 14a, second sensor 14b, push switch (SW) 16, and traffic control center 50.

Storage unit 112 stores lane information that indicates a lane to be controlled by traffic light 12, for example, the lane ID described above. Storage unit 112 also stores a position of traffic light 12 that controls travelling based on the lane information, a position of stop line 22 on the lane in the lane information, bypass information, and a lane ID of a lane on which construction site 30 is present in a corresponding manner. That is, storage unit 112 stores first road information corresponding these information items of the first lane (ID1) and second road information corresponding to these information items of the second lane (ID10). The second road information can be indicated by a combination of a plurality of nodes. Each of the nodes includes its position information. The bypass information indicates a bypass along which vehicle 20 travelling in the lane indicated by the lane information will travel. The bypass information is indicated by a combination of coordinates of nodes constituting bypass 40. Specific examples of information stored in storage unit 112 will be described later.

Traffic light information is input from traffic light 12 to input unit 110. As described above, the traffic light information includes a status and a time before status change. As the status and the time before status change change over time, the status and the time before status change are also referred to as dynamic traffic light information. The dynamic traffic light information is generated based on control of traffic light 12 by traffic control center 50. That is, input unit 110 is set so as to receive input of state information of the traffic light (traffic light 12) for the first lane (ID1).

A detection result is input from sensor 14 to input unit 110. The detection result will be described in further detail with reference to FIG. 1. It is assumed that first traffic light 12a is red and second traffic light 12b is green. This corresponds to a case where vehicle 20 in the inbound lane stops and vehicle 20 in the outbound lane travels. In this case, vehicle 20 passes through first detection range 32a and then second detection range 32b. For this reason, first sensor 14a detects vehicle 20 and then second sensor 14b detects vehicle 20. Specifically, when first sensor 14a and second sensor 14b do not detect vehicle 20, vehicle 20 is not present in traffic restriction section 42 of bypass 40. When first sensor 14a detects vehicle 20 and second sensor 14b does not detect vehicle 20, vehicle 20 is present in traffic restriction section 42. Moreover, when first sensor 14a does not detect vehicle 20 and second sensor 14b detects vehicle 20, vehicle 20 is not present in traffic restriction section 42. The detection result input to input unit 110 thus corresponds to presence of vehicle 20 in traffic restriction section 42 when vehicle 20 travels in the outbound lane. Whether vehicle 20 travels in the outbound lane is determined based on the traffic light information described above.

Next, it is assumed that first traffic light 12a is green and second traffic light 12b is red. This corresponds to a case where vehicle 20 in the inbound lane travels and vehicle 20 in the outbound lane stops. In this case, vehicle 20 passes through second detection range 32b and then first detection range 32a. For this reason, second sensor 14b detects vehicle 20 and then first sensor 14a detects vehicle 20. Specifically, when second sensor 14b and first sensor 14a do not detect vehicle 20, vehicle 20 is not present in traffic restriction section 42 of bypass 40. When second sensor 14b detects vehicle 20 and first sensor 14a does not detect vehicle 20, vehicle 20 is present in traffic restriction section 42. Moreover, when second sensor 14b does not detect vehicle 20 and first sensor 14a detects vehicle 20, vehicle 20 is not present in traffic restriction section 42. The detection result input to input unit 110 thus corresponds to the presence of vehicle 20 in traffic restriction section 42 when vehicle 20 travels in the inbound lane. That is, the detection result input to input unit 110 is also obstacle information that indicates vehicle 20 travelling in traffic restriction section 42 in a direction different from a direction in which another vehicle 20, which stops, travels.

Push SW 16 is a switch that is pressed by a traffic manager such as a policeman or a construction site manager. Every time push SW 16 is pressed, push SW 16 outputs instruction information that causes self-driving vehicle 20 to stop or continue self-driving. The instruction information is also input to input unit 110. That is, the instruction information that causes self-driving vehicle 20 to stop self-driving can be input to input unit 110. Input unit 110 outputs various pieces of information input to processing unit 114.

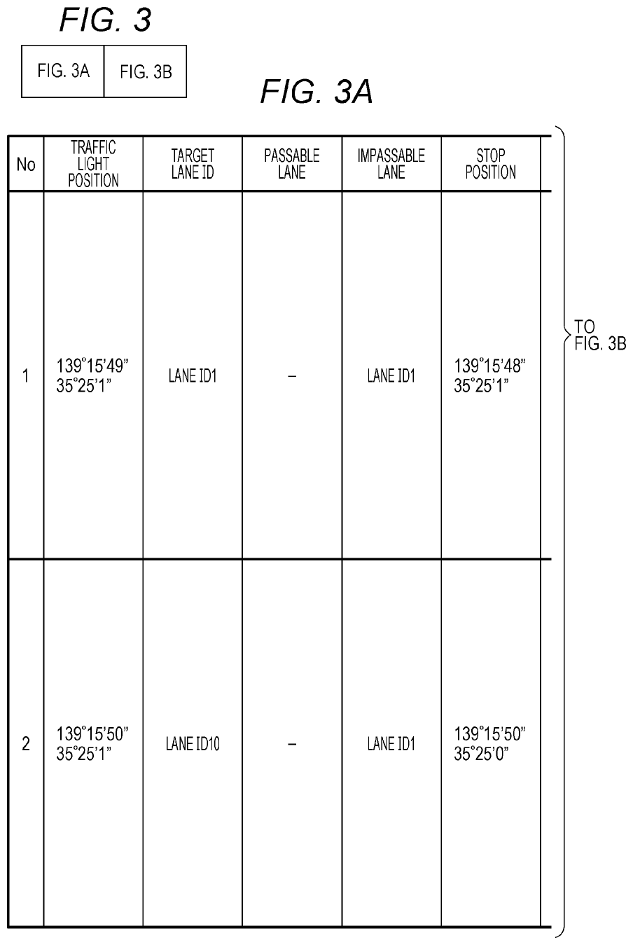

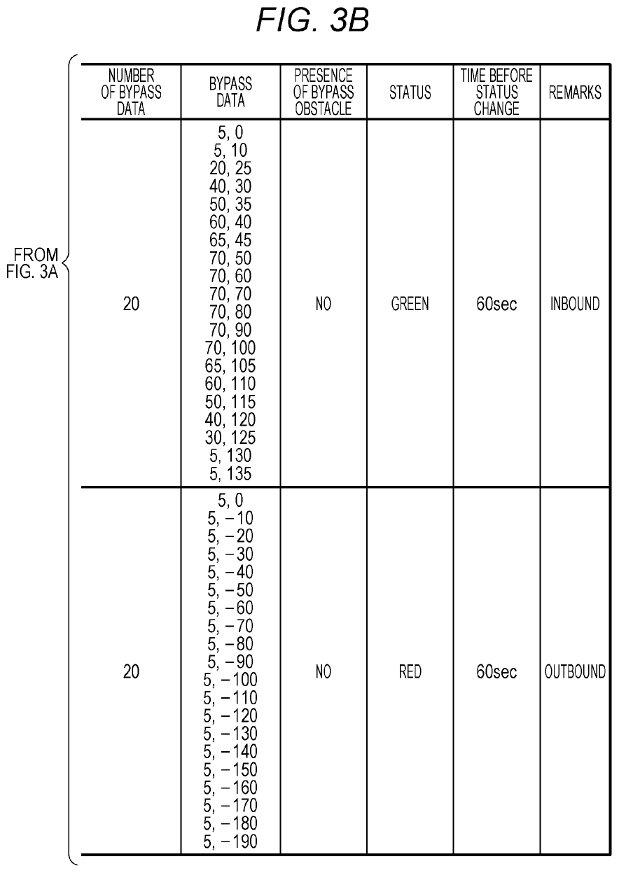

Processing unit 114 extracts information stored in storage unit 112, and various information from input unit 110 is input to processing unit 114. Processing unit 114 then generates a packet signal containing the various pieces of information. The packet signal is also referred to as “traffic light information”. FIG. 3 is a table showing a data structure of traffic light information transmitted from roadside device 10. “Traffic light position” is a position of traffic light 12. The traffic light position for “No. 1” is the position of first traffic light 12a. The traffic light position for “No. 2” is the position of second traffic light 12b. “Target lane ID” is the ID of a lane to be controlled by traffic light 12. The target lane ID for “No. 1” is ID1 and the target lane ID for “No. 2” is ID10. “Impassable lane” indicates the ID of a lane on which construction site 30 is present, and is ID1 in this case.

“Stop position” indicates a position of stop line 22. The stop position for “No. 1” is the position of first stop line 22a. The stop position for “No. 2” is the position of second stop line 22b. “Number of bypass data” indicates a number of nodes constituting bypass 40 and is “20” in this case. “Bypass data” indicates a combination of coordinates of nodes constituting bypass 40. The coordinate of a node is indicated by its relative position when the position of stop line 22 is set to the origin, and is represented in the unit of 0.01 seconds. “Presence of bypass obstacle” indicates obstacle information. “Status” and “time before status change” indicate traffic light information. Although not shown in FIG. 3, instruction information may be included. The description returns to FIG. 2. Processing unit 114 outputs the packet signal generated to communication unit 116.

As described above, communication unit 116 performs a communication process compatible with ITS in the 700 MHz band. The packet signal from processing unit 114 is input to transmitter 118, and transmitter 118 broadcasts the packet signal. That is, transmitter 118 may be regarded as an output unit or an output circuit that outputs a packet signal. While communication unit 116 also has receiving capability, a description thereof will be omitted.

When the state information of traffic light 12 input to input unit 110 indicates prohibition of traffic, transmitter 118 broadcasts a packet signal to output first road information corresponding to the first lane (ID1), second road information at least partially corresponding the second lane (ID10), and information that the second road information is substituted for the first road information. Such an operation is performed under control of processing unit 114. The prohibition of traffic indicated by the state information of traffic light 12 is a state where traffic light 12 is red.

Transmitter 118 can output instruction information that causes self-driving vehicle 20 to stop self-driving. Transmitter 118 can also output obstacle information related to the second road information of the second lane.

Transmitter 118 includes antenna 118a. Antenna 118a outputs the first road information, the second road information, and the information that the second road information is substituted for the first road information as a radio signal.

These configurations can be implemented using a central processing unit (CPU), a memory, and other large scale integration (LSI) of any given computer in terms of hardware and using a program loaded in the memory in terms of software. The drawings herein illustrate functional blocks achieved through coordination of these components. Hence, it will be understood by those skilled in the art that these functional blocks can be achieved in various forms by the hardware alone or by combinations of the hardware and the software. That is, any of roadside device 10, input unit 110, storage unit 112, processing unit 114, communication unit 116, and transmitter 118 can be achieved as a hardware circuit. Input unit 110 can be achieved as a hardware connector.

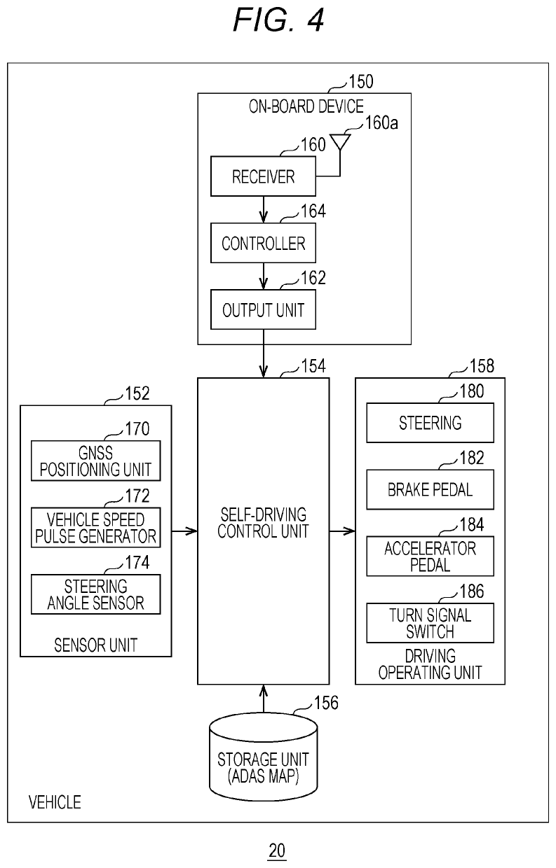

FIG. 4 illustrates a configuration of vehicle 20. Vehicle 20 includes on-board device 150, sensor unit 152, self-driving control unit 154, storage unit 156, and driving operating unit 158. On-board device 150 includes receiver 160, output unit 162, and controller 164. Sensor unit 152 includes global navigation satellite system (GNSS) positioning unit 170, vehicle speed pulse generator 172, and steering angle sensor 174. Driving operating unit 158 includes steering 180, brake pedal 182, accelerator pedal 184, and turn signal switch 186.

Steering 180, brake pedal 182, accelerator pedal 184, and turn signal switch 186 can be electronically controlled by a steering electronic control unit (ECU), a brake ECU, at least one of an engine ECU and a motor ECU, and an indicator controller, respectively. In a self-driving mode, the steering ECU, the brake ECU, the engine ECU, and the motor ECU drive actuators according to control signals supplied from self-driving control unit 154. The indicator controller turns on or off an indicator lamp according to a control signal supplied from self-driving control unit 154.

GNSS positioning unit 170 has GNSS positioning capability and acquires position information of vehicle 20 on which on-board device 150 is mounted. Any publicly known technique only needs to be used for acquiring the position information, and thus description of such a process will be omitted herein. The position information is represented by a latitude and a longitude, for example. Vehicle speed pulse generator 172 obtains a current speed of vehicle 20 based on vehicle speed pulses. Steering angle sensor 174 obtains a steering angle of a steering of vehicle 20. Sensor unit 152 detects a surrounding situation and a traveling state of vehicle 20. Sensors other than GNSS positioning unit 170, vehicle speed pulse generator 172, and steering angle sensor 174, for example, a camera, a millimeter-wave radar, a light detection and ranging, laser imaging detection and ranging (LIDAR), a temperature sensor, an atmospheric pressure sensor, a humidity sensor, and an illuminance sensor may be mounted on sensor unit 152. Sensor unit 152 outputs various pieces of information detected (hereinafter, “detection information”) to self-driving control unit 154.

Self-driving control unit 154 applies a control command and various pieces of information collected from sensor unit 152 or various ECUs to a self-driving algorithm, and calculates a control value to control an automatic control target such as a travel direction of vehicle 20. Self-driving control unit 154 transmits the calculated control value to the ECU or the controller of the corresponding control target. In the present exemplary embodiment, the calculated control value is transmitted to the steering ECU, the brake ECU, the engine ECU, and the indicator controller. In particular, self-driving control unit 154 controls driving operating unit 158 so as to determine a self-driving route using an advanced driver assistance system (ADAS) map, which is the map data stored in storage unit 156, and to cause vehicle 20 to travel along the self-driving route. The lane ID information described above is also stored in the ADAS map. For an electrically driven vehicle or a hybrid car, the control value is transmitted to the motor ECU instead of or in addition to the engine ECU.

On-board device 150 performs the communication process compatible with ITS in the 700 MHz band. Receiver 160 receives a packet signal from roadside device 10. The received packet signal contains the information described above. That is, receiver 160 may be regarded as an input unit or an input circuit that inputs the packet signal from roadside device 10. Receiver 160 includes antenna 160a. Antenna 160a receives radio signals. Receiver 160 receives input of first road information corresponding to the first lane, second road information at least partially corresponding the second lane, and information that the second road information is substituted for the first road information, as a radio signal received by antenna 160a. Output unit 162 outputs information contained in the packet signal received by receiver 160 to self-driving control unit 154. While on-board device 150 also has transmitting capability, a description thereof will be omitted.

When receiver 160 receives input of the first road information corresponding to the first lane, the second road information at least partially corresponding the second lane, and the information that the second road information is substituted for the first road information before a vehicle travels in the first lane, output unit 162 outputs information to self-driving control unit 154 to cause the vehicle to travel on the second road indicated by the second road information instead of the first road indicated by the first road information.

Controller 164 controls operations of receiver 160 and output unit 162.

Self-driving control unit 154 performs self-driving of vehicle 20 along a self-driving route. In such a situation, when the information from output unit 162 is input to self-driving control unit 154, self-driving control unit 154 extracts a target lane ID, a traffic light position, and a stop position from the information. When the target lane ID is a lane ID of a lane in which vehicle 20 is travelling or a lane ID of a lane in which vehicle 20 will travel, and the traffic light position and the stop line position are included in a route to be traveled by vehicle 20, self-driving control unit 154 proceeds to a next process. When the traffic light position and the stop position are included in the route to be traveled by vehicle 20, it means that traffic light 12 is installed within a vehicle control target range. Meanwhile, when any one of these conditions is not satisfied, self-driving control unit 154 causes vehicle 20 to continue to travel along the self-driving route.

When self-driving control unit 154 proceeds to the next step and vehicle 20 reaches stop line 22, self-driving control unit 154 sets bypass 40 based on the number of bypass data, bypass data, and an impassable lane. Self-driving control unit 154 also controls travelling or stopping of vehicle 20 on bypass 40 based on a status, a time before status change, and presence of a bypass obstacle. When the control of self-driving by self-driving control unit 154 enables vehicle 20 to reach an end of bypass 40, self-driving control unit 154 changes bypass 40 to the self-driving route. Self-driving control unit 154 performs self-driving of vehicle 20 along the self-driving route.

With such processes, when vehicle 20 travels in the lane with the target lane ID, output unit 162 causes self-driving control unit 154 to change the self-driving route to bypass 40 and then causes vehicle 20 to travel according to the traffic light information or the like. Output unit 162 also causes self-driving control unit 154 to return to the self-driving route when vehicle 20 has passed bypass 40. When the information includes instruction information and the instruction information indicates stopping of self-driving, self-driving control unit 154 switches from a self-driving mode to a manual driving mode.

As self-driving control unit 154 executes control as described above, vehicle 20 travels based on the second road information corresponding to the second lane instead of the first road information corresponding to the first lane, and then returns to the route determined based on the map data.

These configurations can be implemented using a central processing unit (CPU), a memory, and other large scale integration (LSI) of any given computer in terms of hardware and using a program loaded in the memory in terms of software. The drawings herein illustrate functional blocks achieved through coordination of these components. Hence, it will be understood by those skilled in the art that these functional blocks can be achieved in various forms by the hardware alone or by combinations of the hardware and the software. For example, any of receiver 160, output unit 162, and controller 164 can be achieved as a hardware circuit.

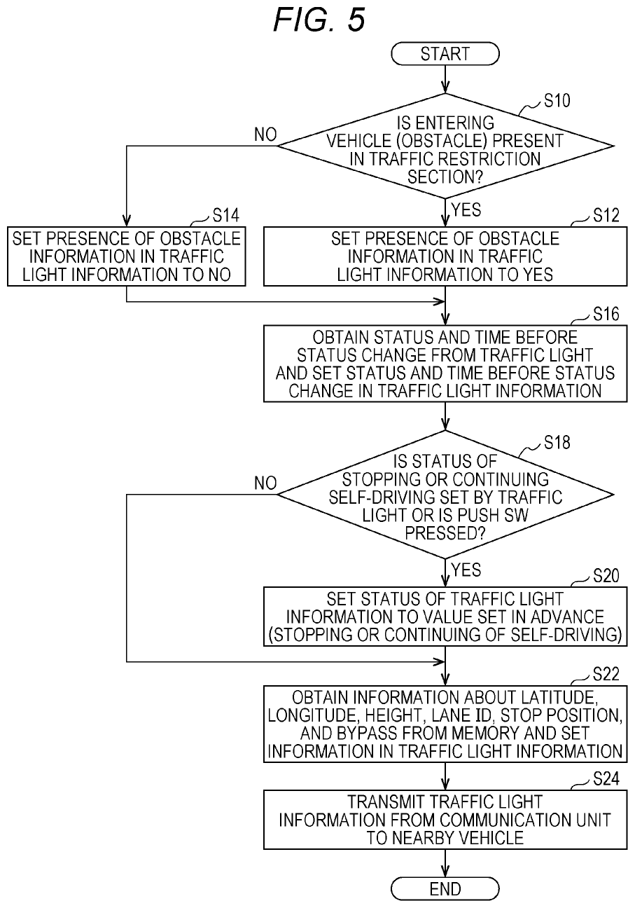

An operation of communication system 100 having the above configuration will be described. FIG. 5 is a flowchart illustrating a transmission procedure to be performed by roadside device 10. In roadside device 10, dynamic traffic light information of traffic light 12 and a detection result of sensor 14 are input to input unit 110. Input unit 110 determines whether an entering vehicle (obstacle) such as vehicle 20 is present in traffic restriction section 42 based on these pieces of information (S10). When entering vehicle 20 is present in traffic restriction section 42 (Y at S10), processing unit 114 sets the presence of obstacle information in the traffic light information to YES (S12). When entering vehicle 20 is not present in traffic restriction section 42 (N at S10), processing unit 114 sets the presence of the obstacle information in the traffic light information to NO (S14). Processing unit 114 obtains a status and a time before status change from traffic light 12 and sets the status and the time before status change in the traffic light information (S16).

When a status of stopping or continuing self-driving is set by traffic light 12 or when push SW 16 is pressed (Y at S18), processing unit 114 sets the status of the traffic light information to a value set in advance (stopping or continuing of self-driving) (S20). When the status of stopping or continuing self-driving is not set by traffic light 12 and when push SW 16 is not pressed (N at S18), step S20 is skipped. Processing unit 114 obtains information about a latitude, a longitude, a height, a lane ID, a stop position, and a bypass from storage unit 112 functioning as a memory and sets the information in the traffic light information (S22). Communication unit 116 transmits the traffic light information to nearby vehicle 20 (S24).

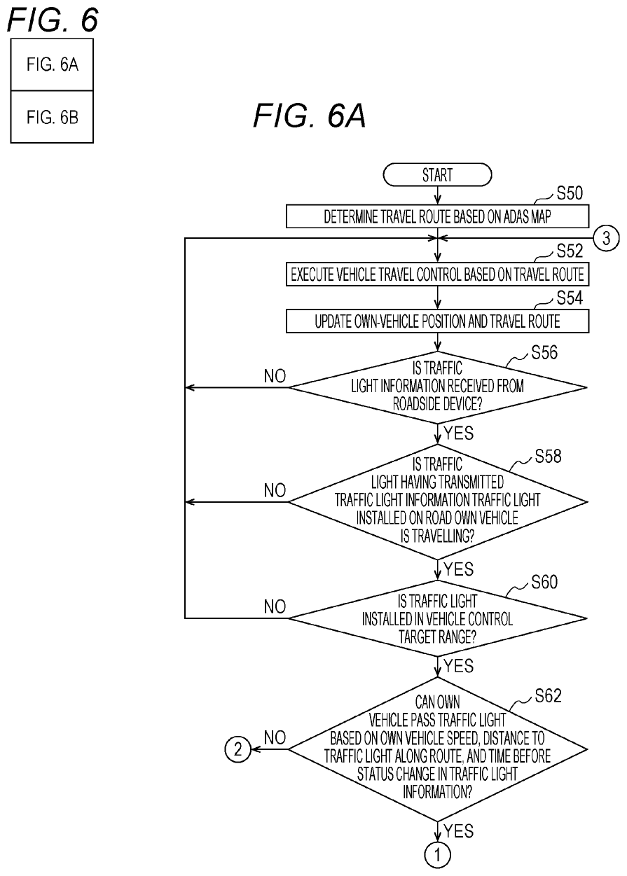

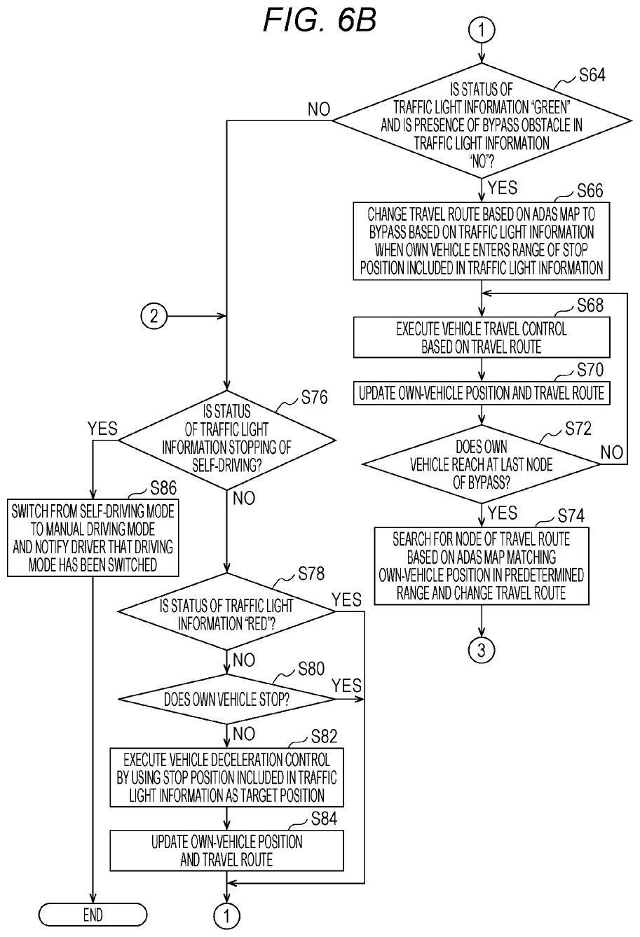

FIG. 6 is a flowchart illustrating a reception procedure to be performed by on-board device 150 in vehicle 20. Self-driving control unit 154 determines a travel route based on an ADAS map stored in storage unit 156 (S50) and executes vehicle travel control based on the travel route (S52). Self-driving control unit 154 updates an own-vehicle position and the travel route (S54). When receiver 160 receives traffic light information (packet signal) from roadside device 10 (Y at S56), output unit 162 outputs lane information, bypass information, and traffic light information included in the traffic light information (packet signal) received to self-driving control unit 154. Self-driving control unit 154 then determines whether the traffic light having transmitted the traffic light information is traffic light 12 installed on the road on which the own vehicle is travelling (S58). When the traffic light having transmitted the traffic light information is traffic light 12 that is installed on the road on which the own vehicle is travelling (Y at S58) and traffic light 12 is installed within a vehicle control target range (Y at S60), self-driving control unit 154 determines whether the own vehicle can pass traffic light 12 based on a speed of the own vehicle, a distance to traffic light 12 along the route, and a time before status change in the traffic light information (S62). When receiver 160 does not receive the traffic light information from roadside device 10 (N at S56), when the traffic light having transmitted the traffic light information is not traffic light 12 installed on the road on which the own vehicle is travelling (N at S58), or when traffic light 12 is not installed within the vehicle control target range (N at S60), the process returns to step S52.

When the own vehicle can pass traffic light 12 (Y at S62), if the status of the traffic light information is “green” and the presence of a bypass obstacle in the traffic light information is “NO” (Y at S64), self-driving control unit 154 changes the travel route based on the ADAS map to bypass 40 in the traffic light information when the own vehicle enters a range of the stop position included in the traffic light information (S66). Self-driving control unit 154 executes the vehicle travel control based on the travel route (S68) and updates the own-vehicle position and the travel route (S70). When the own vehicle does not reach a last node of the bypass (N at S72), the process returns to step S68. When the own vehicle reaches the last node of the bypass (Y at S72), self-driving control unit 154 searches for a node of the travel route based on the ADAS map that matches the own-vehicle position in a predetermined range and changes the travel route (S74), and the process returns to step S52.

When the own vehicle cannot pass traffic light 12 (N at S62) or when the status of the traffic light information is “red” or the presence of the bypass obstacle in the traffic light information is “YES” (N at S64), if the status of the traffic light information is not stopping of self-driving (N at S76), the status of the traffic light information is not “red” (N at S78), and the own vehicle does not stop (N at S80), self-driving control unit 154 executes vehicle deceleration control by using the stop position included in the traffic light information as a target position (S82). Self-driving control unit 154 updates the own-vehicle position and the travel route (S84) and the process returns to step S64. When the status of the traffic light information is “red” (Y at S78) or when the own vehicle stops (Y at S80), the process returns to step S64. When the status of the traffic light information is stopping of self-driving (Y at S76), self-driving control unit 154 switches from a self-driving mode to a manual driving mode and notifies a driver that a driving mode has been switched (S86), and the process ends.

According to the present exemplary embodiment, bypass information that indicates a bypass to be travelled by a vehicle is transmitted and thus during traffic restrictions, a plurality of vehicles can travel along the bypass in a similar manner. As the vehicles can travel along the bypass in a similar manner, the vehicles can travel safely during traffic restrictions. As the vehicles can travel safely, it is possible to reduce traffic jams. In addition, as the bypass information is indicated by a combination of nodes constituting a bypass, the bypass can be set precisely. Moreover, as the bypass is set precisely, the bypass can be set according to the situation of traffic restrictions.

As instruction information that stops self-driving is transmitted, if a vehicle is difficult to continue self-driving, it is possible to stop self-driving. If a vehicle is difficult to continue self-driving, self-driving is stopped and thus safety is improved. Additionally, obstacle information that indicates the presence of other vehicles is transmitted. Consequently, a vehicle does not start if other vehicles are present and thus safety is improved.

As the bypass information that indicates a bypass to be travelled by a vehicle is transmitted and thus during traffic restrictions, a plurality of vehicles can travel safely. In addition, a vehicle changes a self-driving route to a bypass and then returns to the self-driving route, and thus the vehicle can easily travel along the bypass. As the instruction information that stops self-driving is transmitted, it is possible to stop self-driving. Additionally, the vehicle receives the obstacle information that indicates the presence of other vehicles and thus safety is improved.

### Second Exemplary Embodiment

Next, a second exemplary embodiment will be described. The second exemplary embodiment relates to a communication system that performs communication between a roadside device installed on a road and an on-board device mounted on a vehicle, similarly to the first exemplary embodiment. A self-driving vehicle is also assumed in a following description. It is assumed in the first exemplary embodiment that a road is closed to traffic due to road construction or the like and a traffic light is temporarily installed near a construction site. A bypass is thus set so as to avoid the construction site in the first exemplary embodiment, and thus the bypass is configured by a combination of a plurality of nodes. Meanwhile, it is assumed in the second exemplary embodiment that at least one of roads connected to an intersection is closed to traffic. It is only required in the second exemplary embodiment that a direction in which a vehicle can travel is indicated as a bypass, and thus the bypass is configured by a lane ID of a passable lane. Roadside device 10 and vehicle 20 according to the second exemplary embodiment are similar to roadside device 10 illustrated in FIG. 2 and vehicle 20 illustrated in FIG. 4, respectively. Differences from the above description will be mainly described below.

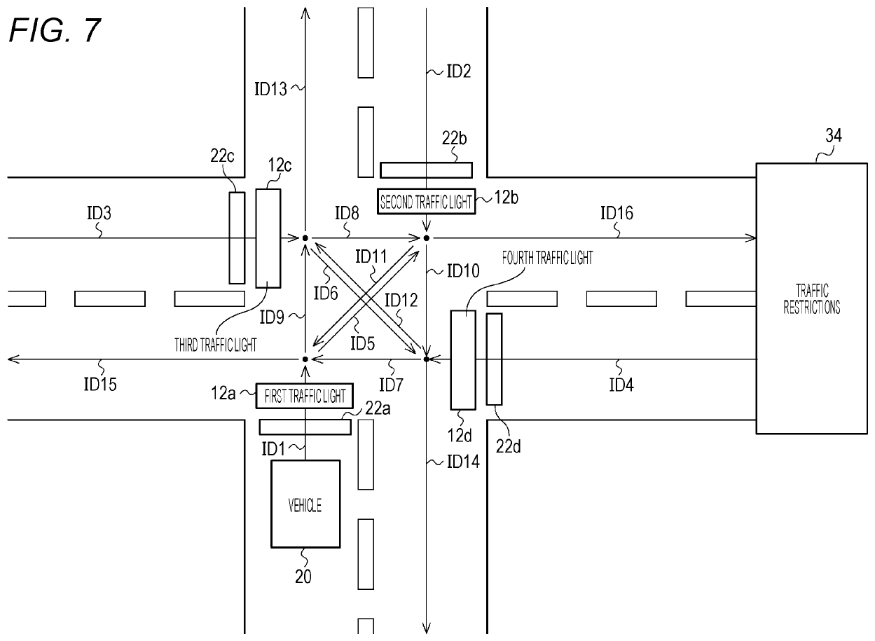

FIG. 7 is a diagram illustrating a configuration of communication system 100 according to the second exemplary embodiment of the present invention. As illustrated in FIG. 7, a horizontally extending road intersects with a vertically extending road at an intersection. A lane ID is given to each lane. For example, ID1 to ID4 are respectively given to a lane entering the intersection from bottom, a lane entering the intersection from top, a lane entering the intersection from left, and a lane entering the intersection from right. ID7 to ID10 are given to straight lanes, and ID5, ID6, ID11, and ID12 are given to right turn lanes.

First traffic light 12a is a traffic light for vehicle 20 travelling in the lane of ID1, and second traffic light 12b is a traffic light for vehicle 20 travelling in the lane of ID2. Third traffic light 12c is a traffic light for vehicle 20 travelling in the lane of ID3, and fourth traffic light 12d is a traffic light for vehicle 20 travelling in the lane of ID4. These traffic lights are connected to traffic control center 50 (not shown) and turn green or red based on instructions from traffic control center 50. First stop line 22a to fourth stop line 22d are placed on the lanes of ID1 to ID4, respectively. It is assumed that traffic restrictions 34 are imposed on a road extending right from the intersection, that is, a road including the lanes of ID4 and ID16. Traffic restrictions 34 include a situation of under construction and a situation of an event being held, for example.

A bypass is indicated as follows in such a case. When the vertically extending road can be travelled and the horizontally extending road is closed to traffic at the intersection (hereinafter, “case 1”), passable lanes are lane “ID9” to which the lane of ID1 is connected straight and lane “ID10” to which the lane of ID2 is connected straight. Meanwhile, impassable lanes are lane “ID5” to which the lane of ID1 is connected by a right turn and lane “ID15” to which the lane of ID1 is connected by a left turn, lane “ID11” to which the lane of ID2 is connected by a right turn, and lane “ID16” to which the lane of ID2 is connected by a left turn. In addition, lanes “ID8”, “ID13”, “ID6”, and “ID9” connected to the lane of ID3, and lanes “ID7”, “ID14”, “ID12”, and “ID10” connected to the lane of ID4 are also impassable lanes. The bypass is thus indicated by instructing vehicles 20 travelling in the lanes of ID1 and ID2 to travel only straight.

When the horizontally extending road can be travelled and the vertically extending road is closed to traffic at the intersection (hereinafter, “case 2”), the passable lane is lane “ID6” to which the lane of ID3 is connected by a right turn. Meanwhile, impassable lanes are lanes “ID8” to which the lane of ID3 is connected straight and lane “ID13” to which the lane of ID3 is connected by a left turn. In addition, lanes “ID9”, “ID15”, “ID5”, and “ID7” connected to the lane of ID1 are also impassable lanes. Lanes “ID10”, “ID16”, “ID11”, and “ID8” connected to the lane of ID2 are also impassable lanes. Lanes “ID7”, “ID14”, “ID12”, and “ID10” connected to the lane of ID4 are also impassable lanes. The bypass is thus indicated by instructing vehicles 20 travelling in the lane of ID3 to turn right only.

Roadside device 10 illustrated in FIG. 2 broadcasts a packet signal as traffic light information similarly to the first exemplary embodiment. However, push SW 16 is pressed at a timing when the traffic light information is to be transmitted in the second exemplary embodiment. When push SW 16 is pressed, push SW 16 notifies input unit 110 that push SW 16 has been pressed. Every time input unit 110 receives a notification from push SW 16 or every time data is input from traffic control center 50 to input unit 110 via traffic light 12, processing unit 114 generates a packet signal and transmitter 118 transmits the packet signal. The packet signal contains bypass information. In the first exemplary embodiment, the bypass information is indicated by a combination of the number of bypass data and bypass data. Meanwhile, in the second exemplary embodiment, the bypass information is indicated by a combination of passable lanes and impassable lanes. This means that the bypass information is indicated by the ID of a lane connected to a lane of a target lane ID.

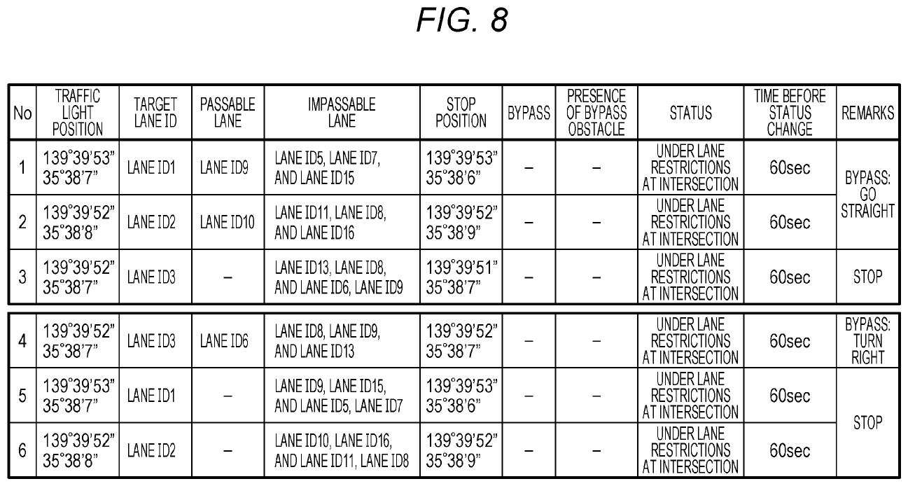

FIG. 8 is a table showing a data structure of traffic light information transmitted from roadside device 10 according to the second exemplary embodiment of the present invention. Information items “No. 1” to “No. 3” correspond to information of case 1, and information items “No. 4” to “No. 6” correspond to information of case 2. As described above, a bypass is indicated by a passable lane and an impassable lane. When “status” is under lane restrictions at an intersection, certain traffic restrictions are imposed.

Receiver 160 illustrated in FIG. 4 receives a packet signal from roadside device 10. The packet signal contains the information shown in FIG. 8. On-board device 150 in vehicle 20 uses the information contained in the packet signal to perform similar processes to those of the first exemplary embodiment.

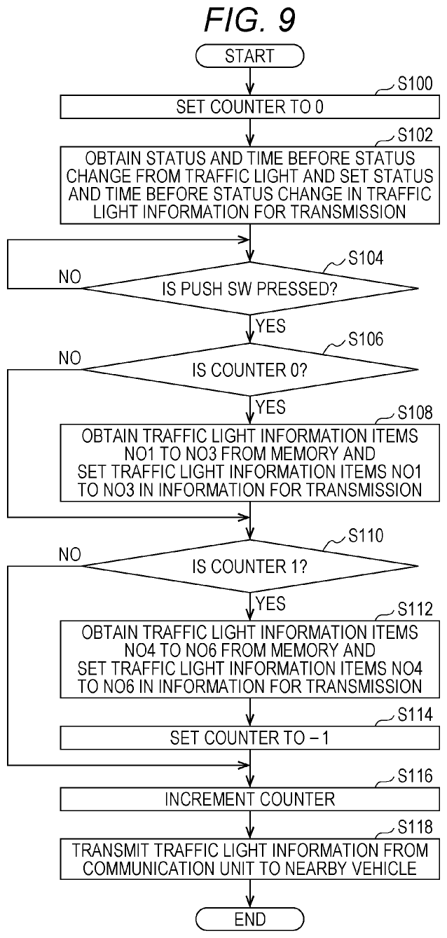

FIG. 9 is a flowchart illustrating a transmission procedure to be performed by roadside device 10 according to the second exemplary embodiment of the present invention. Processing unit 114 sets a counter to 0 (S100). Processing unit 114 obtains a status and a time before status change from traffic light 12 and sets the status and the time before status change in traffic light information for transmission (S102). When push SW 16 is not pressed (N at S104), roadside device 10 is on standby. When push SW 16 is pressed (Y at S104) and the counter is 0 (Y at S106), processing unit 114 obtains the traffic light information items No. 1 to No. 3 from storage unit 112 functioning as a memory and sets these information items in the information for transmission (S108). When the counter is not 0 (N at S106), step S108 is skipped. When the counter is 1 (Y at S110), processing unit 114 obtains the traffic light information items No. 4 to No. 6 from storage unit 112 functioning as a memory and sets these information items in the information for transmission (S112). Processing unit 114 sets the counter to −1 (S114). When the counter is not 1 (N at S110), steps S112 and S114 are skipped. Processing unit 114 increments the counter (S116). Communication unit 116 transmits the traffic light information to nearby vehicle 20 (S118).

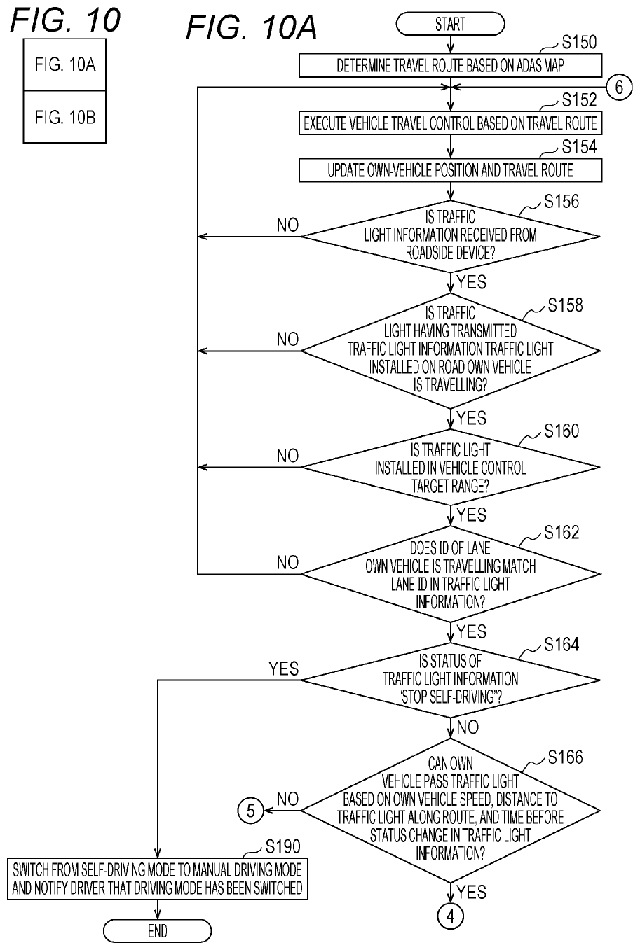

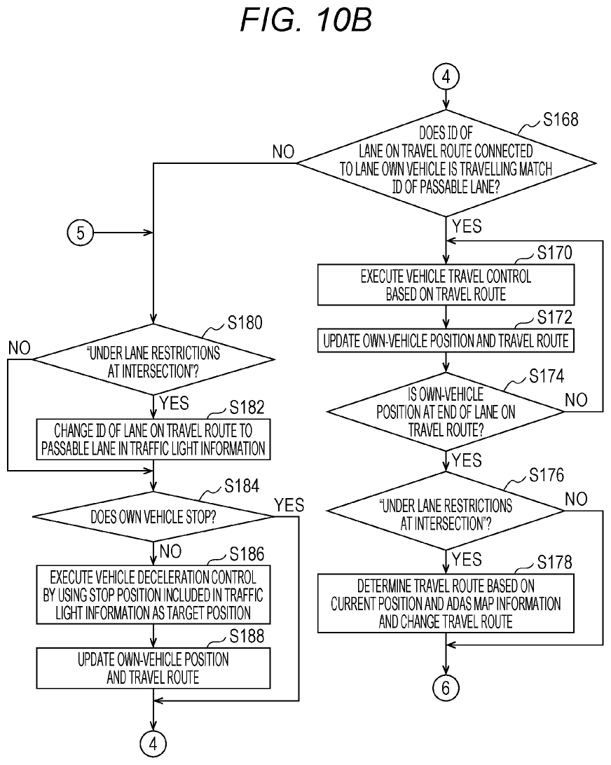

FIG. 10 is a flowchart illustrating a reception procedure to be performed by on-board device 150 in vehicle 20 according to the second exemplary embodiment of the present invention. Self-driving control unit 154 determines a travel route based on an ADAS map stored in storage unit 156 (S150) and executes vehicle travel control based on the travel route (S152). Self-driving control unit 154 updates an own-vehicle position and the travel route (S154). When receiver 160 receives traffic light information from roadside device 10 (Y at S156), the traffic light having transmitted the traffic light information is traffic light 12 that is installed on a road on which the own vehicle is travelling (Y at S158), traffic light 12 is installed within a vehicle control target range (Y at S160), and an ID of a lane in which the own vehicle is travelling matches a lane ID in the traffic light information (Y at S162), self-driving control unit 154 determines whether the status of the traffic light information is stopping of self-driving (S164). When receiver 160 does not receive the traffic light information from roadside device 10 (N at S156), when the traffic light having transmitted the traffic light information is not traffic light 12 installed on the road on which the own vehicle is travelling (N at S158), when traffic light 12 is not installed within the vehicle control target range (N at S160), or when the ID of the lane in which the own vehicle is travelling does not match the lane ID in the traffic light information (N at S162), the process returns to step S152.

When the status of the traffic light information is not stopping of self-driving (N at S164), when the own vehicle can pass traffic light 12 based on a speed of the own vehicle, a distance to traffic light 12 along the route, and the time before status change in the traffic light information (Y at S166), and when the ID of the lane on the travel route connected to the lane in which the own vehicle is travelling matches the ID of the passable lane (Y at S168), self-driving control unit 154 executes the vehicle travel control based on the travel route (S170) and updates the own-vehicle position and the travel route (S172). When the own-vehicle position is not at an end of the lane on the travel route (N at S174), the process returns to step S170. When the own-vehicle position is at the end of the lane on the travel route (Y at S174) and when lane restrictions are imposed at the intersection (Y at S176), self-driving control unit 154 determines a travel route based on a current position and the ADAS map information and changes the travel route (S178). The process then returns to step S152. When lane restrictions are not imposed at the intersection (N at S176), the process returns to step S152.

When the own vehicle cannot pass traffic light 12 based on the speed of the own vehicle, the distance to traffic light 12 along the route, and the time before status change in the traffic light information (N at S166) or when the ID of the lane on the travel route connected to the lane in which the own vehicle is travelling does not match the ID of the passable lane (N at S168), if lane restrictions are imposed at the intersection (Y at S180), self-driving control unit 154 changes the ID of the lane on the travel route to the passable lane included in the traffic light information (S182). When lane restrictions are not imposed at the intersection (N at S180), step S182 is skipped. When the own vehicle does not stop (N at S184), self-driving control unit 154 executes vehicle deceleration control by using the stop position in the traffic light information as a target position (S186). Self-driving control unit 154 updates the own-vehicle position and the travel route (S188) and the process returns to step S168. When the own vehicle stops (Y at S184), the process returns to step S168. When the status of the traffic light information is stopping of self-driving (Y at S164), self-driving control unit 154 switches from a self-driving mode to a manual driving mode and notifies a driver that a driving mode has been switched (S190), and the process ends.

According to the present exemplary embodiment, bypass information is indicated by a next lane, and thus it is possible to set a bypass by specifying a lane ID. As the bypass is set by specifying the lane ID, the bypass can be set easily.

The present invention has been described above based on the exemplary embodiments. It will be understood by those skilled in the art that the exemplary embodiments are merely examples, modifications in which components or processes of the exemplary embodiments are variously combined are possible, and these modifications still fall within the scope of the present invention.

An outline of an aspect of the present invention is as follows. An aspect of the present invention is a roadside device that is configured to adapt to a vehicle road including at least a first lane and a second lane. The roadside device includes an input circuit configured to receive input of state information of a traffic light for the first lane and an output circuit. When the state information of the traffic light input to the input circuit indicates prohibition of traffic, the output circuit outputs first road information corresponding to the first lane, second road information at least partially corresponding the second lane, and information that the second road information is substituted for the first road information.

The aspect allows a plurality of vehicles to travel safely during traffic restrictions.

Another aspect of the present invention is an on-board device that is configured to be mounted on a vehicle that is capable of travelling on a vehicle road including at least a first lane and a second lane. The on-board device includes an input circuit and an output circuit. When the input circuit receives input of first road information corresponding to the first lane, second road information at least partially corresponding the second lane, and information that the second road information is substituted for the first road information before the vehicle travels in the first lane, the output circuit outputs information to the vehicle to cause the vehicle to travel on a second road indicated by the second road information instead of a first road indicated by the first road information.

The aspect allows a plurality of vehicles to travel safely during traffic restrictions.

Yet another aspect of the present invention is a vehicle that is capable of travelling on a vehicle road including at least a first lane and a second lane and of self-driving. The vehicle includes an input circuit. When the input circuit receives input of first road information corresponding to the first lane, second road information at least partially corresponding the second lane, and information that the second road information is substituted for the first road information before the vehicle travels in the first lane during self-driving, the vehicle travels based on the second road information corresponding to the second lane instead of the first road information corresponding to the first lane.

The aspect allows a plurality of vehicles to travel safely during traffic restrictions.

### INDUSTRIAL APPLICABILITY

The roadside device, the on-board device, and the vehicle according to the present invention can allow a plurality of vehicles to travel safely during traffic restrictions, and thus are useful as a roadside device, an on-board device, and a vehicle that transmit or receive signals containing predetermined information.

### REFERENCE MARKS IN THE DRAWINGS

10: roadside device

12, 12a, 12b, 12c, 12d: traffic light

14, 14a, 14b: sensor

16: push SW

20, 20a, 20b: vehicle

22, 22a, 22b, 22d: stop line

30: construction site

32, 32a, 32b: detection range

34: traffic restrictions

40, 40a, 40b: bypass

42: traffic restriction section

50: traffic control center

100: communication system

110: input unit (input circuit)

112: storage unit (storage circuit)

114: processing unit (control circuit)

116: communication unit

118: transmitter (output circuit)

118a: antenna

150: on-board device

152: sensor unit

154: self-driving control unit

156: storage unit

158: driving operating unit

160: receiver (input circuit)

160a: antenna

162: output unit (output circuit)

164: controller (control circuit)

170: GNSS positioning unit

172: vehicle speed pulse generator

174: steering angle sensor

180: steering

182: brake pedal

184: accelerator pedal

186: turn signal switch

1. A roadside device that is configured to adapt to a vehicle road including at least a first lane and a second lane, the roadside device comprising:
an input circuit configured to receive input of traffic light information of a traffic light for the first lane; and
an output circuit,
wherein the output circuit outputs the traffic light information, first road information corresponding to the first lane, second road information at least partially corresponding the second lane, and information that the second road information is substituted for the first road information.

2. The roadside device according to claim 1, further comprising
a control circuit,
wherein the control circuit executes control that the output circuit outputs the traffic light information, the first road information corresponding to the first lane, the second road information at least partially corresponding the second lane, and the information that the second road information is substituted for the first road information.

3. The roadside device according to claim 1, further comprising
a storage circuit,
wherein the storage circuit stores the first road information and/or the second road information.

4. The roadside device according to claim 1, wherein
the output circuit includes an antenna, and
the antenna outputs the first road information, the second road information, and the information that the second road information is substituted for the first road information as a radio signal.

5. The roadside device according to claim 1, wherein
at least the second road information is indicated by a combination of a plurality of nodes.

6. The roadside device according to claim 5, wherein
the nodes respectively include position information of the nodes.

7. The roadside device according to claim 1, wherein
prohibition of traffic indicated by the traffic light information of the traffic light is a state where the traffic light is red.

8. The roadside device according to claim 1, wherein
the output circuit outputs instruction information that causes a vehicle in a self-driving mode to stop self-driving.

9. The roadside device according to claim 8, wherein
instruction information that causes a vehicle in a self-driving mode to stop self-driving is input to the input circuit.

10. The roadside device according to claim 1, wherein
the roadside device is configured to adapt to the vehicle road including at least the first lane and the second lane in a width direction.

11. The roadside device according to claim 10, wherein
the output circuit outputs obstacle information related to the second road information of the second lane.

12. The roadside device according to claim 11, wherein
the obstacle information of the second lane is for other vehicles travelling in a direction different from a direction in which the vehicle travels in the second lane.

13. The roadside device according to claim 10, wherein
obstacle information related to the second road information of the second lane is input to the input circuit.

14. The roadside device according to claim 1, wherein
the roadside device is configured to adapt to the vehicle road further including a third lane in addition to the first lane and the second lane,
the first lane is connected to the third lane, and
the second lane is connected to the third lane.

15. An on-board device that is configured to be mounted on a vehicle that is capable of travelling on a vehicle road including at least a first lane and a second lane, the on-board device comprising:
an input circuit; and
an output circuit,
wherein when the input circuit receives input of traffic light information of a traffic light corresponding to the first lane, first road information corresponding to the first lane, second road information at least partially corresponding the second lane, and information that the second road information is substituted for the first road information before the vehicle travels in the first lane, the output circuit, based on the traffic light information, outputs information to the vehicle to cause the vehicle to travel on a second road indicated by the second road information instead of a first road indicated by the first road information.

16. The on-board device according to claim 15, wherein
the output circuit is configured to output information to a self-driving control unit mounted on the vehicle.

17. The on-board device according to claim 15, wherein
the input circuit includes an antenna, and
the input circuit receives input of the first road information corresponding to the first lane, the second road information at least partially corresponding the second lane, and the information that the second road information is substituted for the first road information, as a radio signal received by the antenna.

18. A vehicle that is capable of travelling on a vehicle road including at least a first lane and a second lane and of self-driving, the vehicle comprising
an input circuit,
wherein when the input circuit receives input of traffic light information of a traffic light corresponding to the first lane, first road information corresponding to the first lane, second road information at least partially corresponding the second lane, and information that the second road information is substituted for the first road information before the vehicle travels in the first lane in a self-driving mode, the vehicle, based on the traffic light information, travels based on the second road information corresponding to the second lane instead of the first road information corresponding to the first lane, and returns to a route determined based on map data after the vehicle travels based on the second road information.

19. (canceled)

20. The vehicle according to claim 18, wherein
a signal to instruct the vehicle to stop the self-driving is input to the input circuit, and
when the input circuit receives input of a signal indicating stopping of the self-driving, the self-driving is stopped.
